(19) United States
(12) Patent Application Publication
(10) Pub. No.: US 2025/0175782 A1
(43) Pub. Date: May 29, 2025

(54) POWER REDUCTION METHOD AND MOBILE COMMUNICATION DEVICE

(71) Applicant: NEXTPERT INC., New Taipei (TW)

(72) Inventors: CHENG-AN CHEN, New Taipei (TW); Jin-Bo Chen, New Taipei (TW); Chang-Hsin Ou, New Taipei (TW)

(21) Appl. No.: 18/928,415

(22) Filed: Oct. 28, 2024

Related U.S. Application Data
(60) Provisional application No. 63/603,753, filed on Nov. 29, 2023.

(51) Int. Cl. H04W 8/02; H04W 52/36

(52) U.S. Cl. CPC H04W 8/02; H04W 52/36

(57) ABSTRACT

A power reduction method and a mobile communication device including: obtaining region identification information after the device is powered on; setting the device as a first power status if first region identification information is obtained; determining whether a hotspot is on if second, third, fourth region identification information is obtained; setting the device as a second power status if the hotspot is on; determining whether sensors are working if the hotspot is off; setting the device as a third power status if any sensor is not working; determining whether the device is in a talking mode if the sensors are working; setting the device as a fourth power status if in the talking mode; determining whether the device is operated if not in the talking mode; setting the device as the first power status if not being operated; setting the device as the third power status if being operated.

### CROSS-REFERENCE TO RELATED APPLICATIONS

This application claims priority to U.S. provisional Application No. 63/603,753 filed on Nov. 29, 2023, in the United States Patent and Trademark Office (USPTO), the contents of which are incorporated by reference herein.

### FIELD

The subject matter herein generally relates to power control of mobile communication devices, and more particularly to a power reduction method and a mobile communication device.

### BACKGROUND

Mobile communication devices which are, but not limited to, smart phone or tablet, smart watch have become a must—have necessity for everyone and those devices equipped the wireless and radiation systems including 5G NR, 4G LTE, 3G WCDMA and Wi-Fi/Bluetooth (BT). All handheld mobile communication devices must meet the standard of Specific Absorption Rate (SAR), which set the radiation power levels well below the limit defined by FCC/IC, CE or JRF. However, when the mobile communication device is in different status, the mobile communication device may need different power configurations for avoiding power waste, therefore, there are still rooms for improving in the art.

### BRIEF DESCRIPTION OF THE DRAWINGS

Implementations of the present disclosure will now be described, by way of embodiments, with reference to the attached figures.

FIG. 1 is a schematic block diagram of a mobile communication device provided by an embodiment of the present disclosure.

FIG. 2 is a schematic flowchart of a power reduction method provided by an embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

Mobile communication devices which are, but is not limited to, smart phone or tablet, smart watch have become a must-have necessity for everyone and those devices equipped the wireless and radiation systems including 5G NR, 4G LTE, 3G WCDMA and Wi-Fi/Bluetooth (BT). All handheld mobile communication devices must meet the standard of Specific Absorption Rate (SAR), which set the radiation power levels well below the limit defined by FCC/IC, CE or JRF. The present application allows mobile wireless products to effectively reduce the harm of Radio frequency (RF) exposure to the human head, body and limb under different region requirements or user scenario by the following advantages:
(1) Mobile country code (MCC) recognition; (2) Error handling when the sensors are broken; (3) Identify multiple user scenarios; (4) Applicable to G-sensor (gravity sensor), Cap-sensor (capacitive sensing sensor) or P-sensor (proximity sensor).

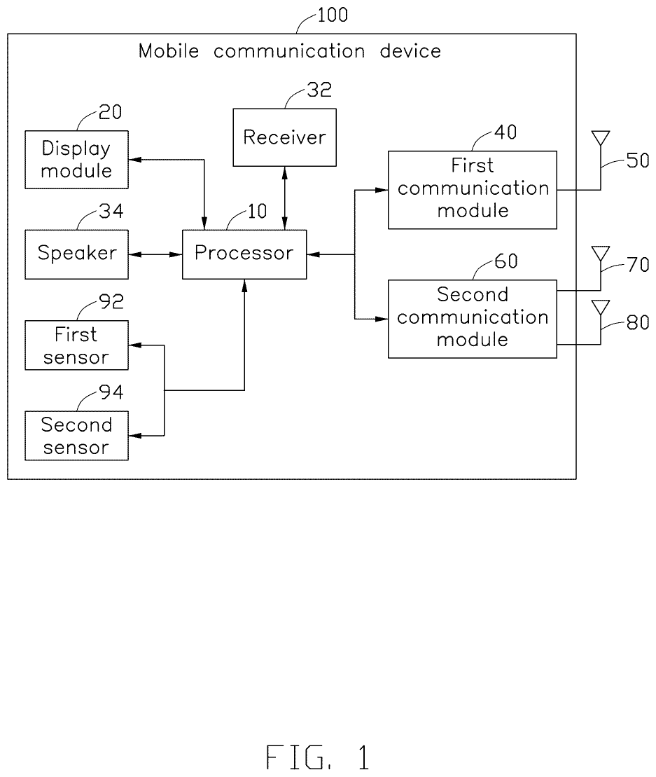

FIG. 1 is a block diagram of a mobile communication device 100 of this application. In at least one embodiment, the mobile communication device 100 may be, but is not limited to, smart phone, tablet computer, smart watch, personal digital assistant (PDA), or portable gaming device, etc.

In at least one embodiment, the mobile communication device 100 may include a processor 10, a display module 20, a receiver 32, a speaker 34, a first communication module 40, a first antenna 50, a second communication module 60, a second antenna 70, a third antenna 80, a first sensor 92, and a second sensor 94.

The processor 10 is connected to the display module 20, the receiver 32, the first communication module 40, the second communication module 60, the first sensor 92, and the second sensor 94, the processor 10 is configured to control and process data of these components. In at least one embodiment, the processor 10 may be, but not is limited to, systems on chip (SOC), a central processing unit (CPU), a microprocessor, a digital signal processor (DSP), a graphics processor, an application specific integrated circuit (ASIC), a field-programmable gate array (FPGA), a data processor chip, a programmable logic device (PLD), a discrete gate/transistor logic device, or a discrete hardware component. The processor 10 may be a control unit and electrically connected to other elements of the mobile communication device 100 through interfaces or a bus. The processor 10 may also be a control circuit formed by several tubes or transistors as switches.

The display module 20 is configured to display a user interface (UI) and receive user's operation. In at least one embodiment, the display module 20 may be, but is not limited to, touch display.

The receiver 32 is configured to convert audio electrical signals into sound signals for incoming calls or outgoing calls of the mobile communication device 100, and provide sound to the user.

The speaker 34 is configured to convert audio electrical signals into sound signals for incoming calls or outgoing calls of the mobile communication device 100, and provide sound to the user. In at least one embodiment, the speaker 34 may have a greater power amplifier for the sound signals than the receiver 32 does.

The first communication module 40 is configured to generate and resolve communication signals to communication with other mobile communication devices. In at least one embodiment, the first communication module 40 may be, but is not limited to, radio frequency (RF) modules, such as Wi-Fi and/or Bluetooth module, the communication signals generated and resolved by the first communication module 40 may be Wi-Fi and/or Bluetooth signals.

The first antenna 50 is connected to the first communication module 40 and is configured to transmit and receive communication signals of the first communication module 40. In at least one embodiment, the first antenna 50 may be, but is not limited to, Wi-Fi and/or Bluetooth antenna.

The second communication module 60 is configured to generate and resolve communication signals to communication with other mobile communication devices. In at least one embodiment, the second communication module 60 may be, but is not limited to, radio frequency (RF) modules, such as 5G NR, 4G LTE, 3G WCDMA modules, the communication signals generated and resolved by the second communication module 60 may be 5G NR, 4G LTE, 3G WCDMA signals.

The second antenna 70 and the third antenna 80 are connected to the second communication module 60 and are configured to transmit and receive communication signals of the second communication module 60. In at least one embodiment, the second antenna 70 may be a main antenna, the third antenna 80 may be a diversity antenna or a multiple input multiple output (MIMO) antenna.

In at least one embodiment, the first communication module 40 and the second communication module 60 can be uniformly named as the RF modules. The output power of RF modules may be different according to different regions or countries and different user scenarios, this design can dynamically adjust the output power according to defined RF power tables for the RF modules to reduce SAR value.

The first sensor 92 is configured to detect a gravity variation of the mobile communication device 100. In at least one embodiment, the first sensor 92 may be, but is not limited to, a gravity sensor (G-sensor).

The second sensor 94 is configured to detect a distance variation between any object and the mobile communication device 100. In at least one embodiment, the second antenna 70 may be, but is not limited to, capacitive sensing sensor (Cap-sensor) or proximity sensor (P-sensor). The second sensor 94 may detect a distance variation between the user (such as the head, the body, the limbs of the user) and the mobile communication device 100.

Those skilled in the art can understand that the schematic diagram is only an example of the mobile communication device 100 and does not constitute a limitation on the mobile communication device 100. The mobile communication device 100 may include more or less components than those shown in the figure, combine certain components, or have different components. For example, the mobile communication device 100 may also include a power source or a battery (not shown) and a memory (not shown).

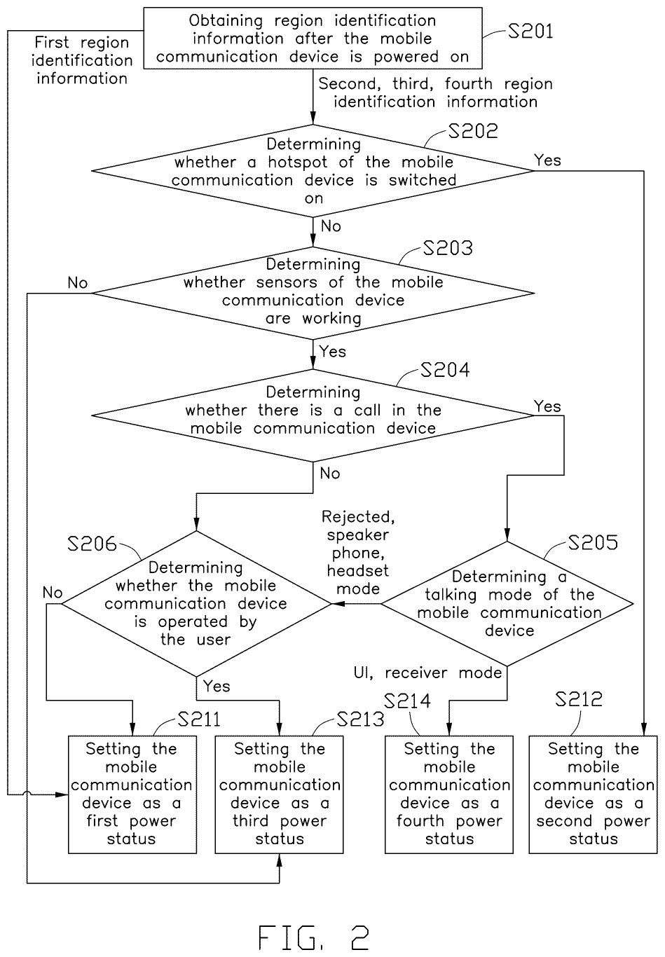

FIG. 2 is a schematic flowchart of a power reduction method, which can be applied in the mobile communication device 100 as shown in FIG. 1. According to different needs, the order of blocks in the flowchart can be changed, and some blocks can be omitted or combined.

At block S201, obtaining region identification information after the mobile communication device is powered on.

In at least one embodiment, after the mobile communication device 100 is powered on, the mobile communication device 100 obtains region identification information to recognize the location of the mobile communication device 100. In at least one embodiment, the region identification information can be Mobile Country Code (MCC), which the mobile communication device 100 can receive from communication base stations to determine the region of the mobile communication device 100. For instance, if the mobile communication device 100 receives the MCC is 001, which will determine the mobile communication device 100 being in a factory production mode. In at least one embodiment, the MCC given by a general test machine in the factory is 001. Since the mobile communication device 100 is in the factory production mode, power reduction mechanism may not be activated, that is, the factory production mode use default max power, such as 200_00 (Power00), to ensure stable production testing according to Power table 0 (200_0), so as to avoid the operator errors causing test instability and misjudgment of the test results. For instance, the MCC may further include FCC/IC, JRF, CE, etc., FCC means Federal Communication Commission defined SAR spec. for U.S., LATAM region also), IC means Industry Canada reuse some FCC spec. for Canada region), the MCC being FCC/IC may be 3XX/7XX/450/535 for example; JRF means SAR spec. for Japan, the MCC being JRF may be 440/441 for example; and CE means Conformité Européenne defined SAR spec for EMEA (Europe, the Middle East and Africa) and Asia, the MCC being CE may be 2XX/4XX/5XX/6XX (excluding 440/441/450/535) for example.

In the block S201, if the mobile communication device 100 obtains first region identification information, the procedure goes to block S211; if the mobile communication device 100 obtains second region identification information, third region identification information, and fourth region identification information, the procedure goes to block S202. In at least one embodiment, the first region identification information may be stand for the factory production mode, the second region identification information may be stand for region of FCC/IC, the third region identification information may be stand for region of, CE and the fourth region identification information may be stand for region of JRF.

At block S211, setting the mobile communication device as a first power status.

In at least one embodiment, if the mobile communication device 100 obtains the first region identification information being stand for the factory production mode, the processor 10 may set the mobile communication device 100 as the first power status. In the first power status, power reduction mechanism may not be activated, that is, the factory production mode use default max power, such as Power00 (200_00), to ensure stable production testing according to Power table 0 (200_0), so as to avoid the operator errors causing test instability and misjudgment of the test results. Additionally, the first power status includes a plurality of power levels corresponding to the second region identification information, the third region identification information, and the fourth region identification information, for instance, Power0a (200_0a), Power0b (200_0b), and Power0c (200_0c) corresponding to FCC/IC, CE, and JRF, respectively. In at least one embodiment, the Power table 0 for the first power status may be listed below:

| item of power level | region | power level |
|---|---|---|
| Power00 | factory | 200_00 |
| | production | |
| | mode | |
| Power0a | FCC/IC | 200_0a |
| Power0b | CE | 200_0b |
| Power0c | JRF | 200_0c |

At block S202, determining whether a hotspot of the mobile communication device is switched on.

In at least one embodiment, the processor 10 determines whether a hotspot of the mobile communication device 100 is switched on for sharing network access to other mobile communication devices or function enabled. It should be known that, when the hotspot of the mobile communication device 100 is switched on, the mobile communication device 100 may work with greater power.

In the block S202, if the hotspot of the mobile communication device is switched on, the procedure goes to block S212; if the hotspot of the mobile communication device is not switched on, the procedure goes to block S203.

At block S212, setting the mobile communication device as a second power status.

In at least one embodiment, if the hotspot of the mobile communication device 100 is switched on, the processor 10 sets the mobile communication device 100 as the second power status. A Power table 3 (200_3) is configured for the second power status, the second power status includes a plurality of power levels corresponding to the second region identification information, the third region identification information, and the fourth region identification information, for instance, Power3a (200_3a), Power3b (200_3b), and Power3c (200_3c) corresponding to FCC/IC, CE, and JRF, respectively. In at least one embodiment, the Power table 3 for the second power status may be listed below:

| item of power level | region | power level |
|---|---|---|
| Power3a | FCC/IC | 200_3a |
| Power3b | CE | 200_3b |
| Power3c | JRF | 200_3c |

At block S203, determining whether sensors of the mobile communication device are working.

In at least one embodiment, if the hotspot of the mobile communication device 100 is not switched on, the processor 10 determines whether the sensors, such as the first sensor 92 and the second sensor 94, of the mobile communication device 100 are working properly. In at least one embodiment, this may be an error handling function that allows the mobile communication device 100 to automatically debug errors. When the mobile communication device 100 detects any abnormal situation of any one of the sensors (such as the first sensor 92 and the second sensor 94), the processors 10 can still ensure that the SAR value does not exceed regulatory requirements. In at least one embodiment, the mobile communication device 100 may detect whether an Inter-Integrated Circuit (I2C) signal of each of the sensors (such as the first sensor 92 and the second sensor 94) is working within a first predetermined time period. In at least one embodiment, the first predetermined time period may be, but is not limited to, 10 or 15 seconds, that is, the mobile communication device 100 may detect whether each of the sensors is working every 10 or 15 seconds.

In at least one embodiment, if any one of the sensors (such as the first sensor 92 or the second sensor 94) is detected to be abnormal or damaged, the procedure goes to block S213; if the sensors (such as the first sensor 92 and the second sensor 94) are detected to be working, the procedure goes to block S204.

At block S213, setting the mobile communication device as a third power status.

In at least one embodiment, if any one of the sensors (such as the first sensor 92 or the second sensor 94) is detected to be abnormal or damaged, the processor 10 sets the mobile communication device 100 as the third power status. A Power table 1 (200_1) is configured for the third power status, the third power status includes a plurality of power levels corresponding to the second region identification information, the third region identification information, and the fourth region identification information, for instance, Power1a (200_1a), Power1b (200_1b), and Power1c (200_1c) corresponding to FCC/IC, CE, and JRF, respectively. In at least one embodiment, the Power table 1 for the third power status may be listed below:

| item of power level | region | power level |
|---|---|---|
| Power1a | FCC/IC | 200_1a |
| Power1b | CE | 200_1b |
| Power1c | JRF | 200_1c |

At block S204, determining whether there is a call in the mobile communication device.

In at least one embodiment, if the sensors (such as the first sensor 92 and the second sensor 94) are detected to be working, the processor 10 determines whether there is a call in the mobile communication device 100. In at least one embodiment, the call may be an incoming call or an outgoing call. In at least one embodiment, if there is a call in the mobile communication device 100, the procedure goes to block S205; if there is no call in the mobile communication device 100, the procedure goes to block S206.

At block S205, determining a talking mode of the mobile communication device.

In at least one embodiment, if the call is an incoming call and the incoming call is answered, the processor 10 will determine the mobile communication device 100 is in the talking mode; or if the call is an outgoing call, the processor 10 will also determine the mobile communication device 100 is in the talking mode, and the block S205 can be omitted. If the mobile communication device 100 is in the talking mode is determined, the mobile communication device 100 will be close to the user's head, so it's needed to ensure the RF radiation of the mobile communication device 100 meeting the requirements of head SAR regulations. In at least one embodiment, the talking mode may include a UI mode and a receiver mode. The UI mode may be handset answering through the user interface (UI) of the mobile communication device 100 is selected by the user. The receiver mode may be the receiver 32 of the mobile communication device 100 is turned on. In at least one embodiment, if the mobile communication device 100 is in the talking mode is determined, and the talking mode is the UI mode or the receiver mode is determined, the procedure goes to block S214.

In at least one embodiment, if the call is an incoming call and the incoming call is not answered, the processor 10 will determine the mobile communication device 100 is not in the talking mode. In at least one embodiment, the talking mode may further include a rejected mode, a speaker phone mode, and a headset mode. When the mobile communication device 100 is in any one of the rejected mode, the speaker phone mode, and the headset mode, the mobile communication device 100 may be worn on the user's body, placed in the user's pocket, or held in the hand to answer the call. The rejected mode may be rejecting the call by the user. The speaker phone mode may be answering the call by selecting the speaker phone through the UI. The headset mode may be a wired headset is inserted into a headset jack of the mobile communication device 100 or a wireless (such as Bluetooth) earpiece is connected to the first communication module 40. In at least one embodiment, if the mobile communication device 100 is in any one of the rejected mode, the speaker phone mode, and the headset mode, the procedure goes to block S206.

At block S206, determining whether the mobile communication device is operated by the user.

In at least one embodiment, the processor 10 may determine whether the mobile communication device 100 is operated by the user. If the mobile communication device 100 being operated by the user is determined, the mobile communication device 100 may be held by the user, the mobile communication device 100 may be closed to the body or the limb of the user, so it needs to be adopted to ensure compliance with body SAR and limb regulations. If the mobile communication device 100 not being operated, for a second predetermined time period for example, by the user is determined, the mobile communication device 100 may be process and turn on the default maximum power according to the Power table 0 (200_0). In at least one embodiment, the processor 10 may determine whether the mobile communication device 100 is operated through user scenario (or occurrence of events), such as an unlocked scenario, a first sensor triggered scenario, a second sensor triggered scenario, a first sensor non-triggered scenario, and a second sensor non-triggered scenario. The unlocked scenario may be a power key of the mobile communication device 100 is pressed by the user to unlock the UI. The first sensor triggered scenario may be a gravity variation of the mobile communication device 100 is greater than or equal to a gravity variation threshold value, if the gravity variation of the mobile communication device 100 is greater than or equal to the gravity variation threshold value, the first sensor 92 triggered is determined, and the mobile communication device 100 being used by the user can be determined. In at least one embodiment, the gravity variation threshold value may be, but is not limited to, 0.5 m/s². The second sensor triggered scenario may be a distance variation of the mobile communication device 100 is greater than or equal to a distance variation threshold value, if the distance variation of the mobile communication device 100 is greater than or equal to the distance variation threshold value, the second sensor 94 triggered is determined, and the mobile communication device 100 being used by the user can be determined. In at least one embodiment, the distance variation threshold value may be, but is not limited to, 80 d (which can be a capacitive sensing value). The first sensor non-triggered scenario may be the gravity variation of the mobile communication device 100 is less than the gravity variation threshold value for a second predetermined time period, if the gravity variation of the mobile communication device 100 is less than the gravity variation threshold value for the second predetermined time period, the first sensor 92 not triggered is determined, and the mobile communication device 100 not being operated by the user can be determined. In at least one embodiment, the second predetermined time period may be, but is not limited to, 15 seconds. The second sensor non-triggered scenario may be the distance variation of the mobile communication device 100 is less than the distance variation threshold value, if the distance variation of the mobile communication device 100 is less than the distance variation threshold value, the second sensor 94 not triggered is determined, and the mobile communication device 100 not being operated by the user can be determined.

In the block S206, if the mobile communication device is operated by the user, the procedure goes to block S213; if the mobile communication device is not operated by the user, the procedure goes to block S211.

At block S214, setting the mobile communication device as a fourth power status.

In at least one embodiment, the mobile communication device 100 is in the talking mode is determined, and the answering mode is the UI mode or the receiver mode is determined, the processor 10 sets the mobile communication device 100 as the fourth power status. A Power table 2 (200_2) is configured for the fourth power status, the fourth power status includes a plurality of power levels corresponding to the second region identification information, the third region identification information, and the fourth region identification information, for instance, Power2a (200_2a), Power2b (200_2b), and Power2c (200_2c) corresponding to FCC/IC, CE, and JRF, respectively. In at least one embodiment, the Power table 2 for the fourth power status may be listed below:

| item of power level | region | power level |
|---|---|---|
| Power2a | FCC/IC | 200_2a |
| Power2b | CE | 200_2b |
| Power2c | JRF | 200_2c |

In at least one embodiment, each of the plurality of power levels of the first power status, the second power status, the third power status, and the fourth power status is different from each other. In at least one embodiment, the power of the plurality of power levels of the first power status may be greater than the power of the plurality of power levels of each of the second power status, the third power status, and the fourth power status. Thus, the mobile communication device 100 can be set with different power reduction when in different usage situation and meeting different SAR regulatory requirements, the mobile communication device 100 can work with proper powers.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A power reduction method for mobile communication device comprising:
obtaining region identification information after the mobile communication device is powered on;
setting a power status of the mobile communication device as a first power status if first region identification information is obtained;
determining whether a hotspot of the mobile communication device is switched on if second region identification information, third region identification information, or fourth region identification information is obtained;
setting the power status of the mobile communication device as a second power status if the hotspot of the mobile communication device is switched on;
determining whether sensors of the mobile communication device are working if the hotspot of the mobile communication device is not switched on;
setting the power status of the mobile communication device as a third power status if any one of the sensors of the mobile communication device is not working;
determining whether the mobile communication device is in a talking mode if the sensors of the mobile communication device are working;
setting the power status of the mobile communication device as a fourth power status if the mobile communication device is in the talking mode;
determining whether the mobile communication device is operated by a user if the mobile communication device is not in the talking mode;
setting the power status of the mobile communication device as the first power status if the mobile communication device is not operated by the user; and
setting the power status of the mobile communication device as the third power status if the mobile communication device is operated by the user.

2. The power reduction method of claim 1, wherein each of the second region identification information, the third region identification information, and the fourth region identification information indicates a country region, the first region identification information indicates a test status;
each of the first power status, the second power status, the third power status, and the fourth power status comprises a plurality of power levels corresponding to the second region identification information, the third region identification information, and the fourth region identification information respectively.

3. The power reduction method of claim 2, wherein each of the plurality of power levels of the first power status, the second power status, the third power status, and the fourth power status is different from each other.

4. The power reduction method of claim 1, wherein the step of determining whether sensors of the mobile communication device are working if the hotspot of the mobile communication device is not switched on, comprises:
determining whether a first sensor and a second sensor are working, the first sensor is different from the second sensor, the first sensor is configured to detect a gravity variation of the mobile communication device, the second sensor is configured to detect a distance variation between any object and the mobile communication device.

5. The power reduction method of claim 4, wherein when a predetermined signal of the first sensor and the second sensor are working within a first predetermined time period, the sensors of the mobile communication device are determined as working;
when the predetermined signal of the first sensor and the second sensor are not working within the first predetermined time period, the sensors of the mobile communication device are determined as not working.

6. The power reduction method of claim 1, wherein the step of determining whether the mobile communication device is in the talking mode if the sensors of the mobile communication device are determined as working, comprises:
determining whether there is a call in the mobile communication device if the sensors of the mobile communication device are determined as working;
determining the talking mode of the mobile communication device if there is a call in the mobile communication device; and
determining the mobile communication device is not in the talking mode if there is no call in the mobile communication device.

7. The power reduction method of claim 6, wherein the step of determining the talking mode of the mobile communication device, comprises:
setting the power status of the mobile communication device as the fourth power status if a receiver of the mobile communication device is turned on; and
determining whether the mobile communication device is operated by the user if the receiver is not turned on.

8. The power reduction method of claim 6, wherein the step of determining whether the mobile communication device is in the talking mode if there is no call in the mobile communication device, further comprises:
determining the mobile communication device is in the talking mode if the call is an incoming call and the incoming call is answered or if the call is an outgoing call;
determining the mobile communication device is not in the talking mode if the call is the incoming call and the incoming call is not answered.

9. The power reduction method of claim 4, wherein the step of determining whether the mobile communication device is not operated by the user, comprises:
determining whether the gravity variation of the mobile communication device is less than the gravity variation threshold value for a second predetermined time period by the first sensor or determining the distance variation of the mobile communication device is less than the distance variation threshold value by the second sensor.

10. The power reduction method of claim 9, wherein the step of setting the power status of the mobile communication device as the third power status if the mobile communication device is operated by the user, comprises:
determining the mobile communication device is operated by the user if determining a power key of the mobile communication device is pressed by the user to unlock an UI, determining the gravity variation of the mobile communication device is greater than or equal to the gravity variation threshold value, or determining the distance variation of the mobile communication device is greater than or equal to the distance variation threshold value.

11. A mobile communication device comprising:
a plurality of sensors configured to detect a status of the mobile communication device;
a processor configured to:
obtain region identification information after the mobile communication device is powered on;
set a power status of the mobile communication device as a first power status if first region identification information is obtained;
determine whether a hotspot of the mobile communication device is switched on if second region identification information, third region identification information, or fourth region identification information is obtained;
set the power status of the mobile communication device as a second power status if the hotspot of the mobile communication device is switched on;
determine whether the plurality of sensors of the mobile communication device are working if the hotspot of the mobile communication device is not switched on;
set the power status of the mobile communication device as a third power status if any one of the plurality of sensors of the mobile communication device is not working;
determine whether the mobile communication device is in a talking mode if the plurality of sensors of the mobile communication device are working;
set the power status of the mobile communication device as a fourth power status if the mobile communication device is in the talking mode;
determine whether the mobile communication device is operated by a user if the mobile communication device is not in the talking mode;
set the power status of the mobile communication device as the first power status if the mobile communication device is not operated by the user; and
set the power status of the mobile communication device as the third power status if the mobile communication device is operated by the user.

12. The mobile communication device of claim 11, wherein each of the second region identification information, the third region identification information, and the fourth region identification information indicates a country region, the first region identification information indicates a test status;
each of the first power status, the second power status, the third power status, and the fourth power status comprises a plurality of power levels corresponding to the second region identification information, the third region identification information, and the fourth region identification information respectively.

13. The mobile communication device of claim 12, wherein each of the plurality of power levels of the first power status, the second power status, the third power status, and the fourth power status is different from each other.

14. The mobile communication device of claim 11, wherein the plurality of sensors comprise a first sensor or a second sensor;
the processor configured to determine whether sensors of the mobile communication device are working if the hotspot of the mobile communication device is not switched on by:
determining whether a first sensor and a second sensor are working, the first sensor is different from the second sensor, the first sensor is configured to detect a gravity variation of the mobile communication device, the second sensor is configured to detect a distance variation between any object and the mobile communication device.

15. The mobile communication device of claim 14, wherein when a predetermined signal of the first sensor and the second sensor are working within a first predetermined time period, the plurality of sensors of the mobile communication device are determined as working;
when the predetermined signal of the first sensor and the second sensor are not working within the first predetermined time period, the plurality of sensors of the mobile communication device are determined as not working.

16. The mobile communication device of claim 11, wherein the processor is configured to determine whether the mobile communication device is in the talking mode if the sensors of the mobile communication device are determined as working by:
determining whether there is a call in the mobile communication device if the sensors of the mobile communication device are determined as working;
determining the talking mode of the mobile communication device if there is a call in the mobile communication device; and
determining the mobile communication device is not in the talking mode if there is no call in the mobile communication device.

17. The mobile communication device of claim 16, wherein the processor is configured to determine the talking mode of the mobile communication device by:
setting the power status of the mobile communication device as the fourth power status if a receiver of the mobile communication device is turned on;
determining whether the mobile communication device is operated by the user if the receiver is not turned on.

18. The mobile communication device of claim 16, wherein the processor is configured to determine whether the mobile communication device is in the talking mode if there is no call in the mobile communication device by:
determining the mobile communication device is in the talking mode if the call is an incoming call and the incoming call is answered or if the call is an outgoing call;
determining the mobile communication device is not in the talking mode if the call is the incoming call and the incoming call is not answered.

19. The mobile communication device of claim 14, wherein the processor is configured to determine whether the mobile communication device is not operated by the user by:
determining whether the gravity variation of the mobile communication device is less than the gravity variation threshold value for a second predetermined time period by the first sensor or determining the distance variation of the mobile communication device is less than the distance variation threshold value by the second sensor.

20. The mobile communication device of claim 19, wherein the processor is configured to set the power status of the mobile communication device as the third power status if the mobile communication device is operated by the user by:
determining the mobile communication device is operated by the user if determining a power key of the mobile communication device is pressed by the user to unlock an UI, determining the gravity variation of the mobile communication device is greater than or equal to the gravity variation threshold value, or determining the distance variation of the mobile communication device is greater than or equal to the distance variation threshold value.
